(19) United States
(12) Patent Application Publication
(10) Pub. No.: US 2006/0217141 A1
(43) Pub. Date: Sep. 28, 2006

(54) Communications power control

(76) Inventors: Peter Legg, Wroughton (GB); Eric Villier, Swindon (GB)

Correspondence Address: MOTOROLA, INC., 1303 EAST ALGONQUIN ROAD, IL01/3RD, SCHAUMBURG, IL, 60196, US

(21) Appl. No.: 10/568,605

(22) PCT Filed: Sep. 1, 2004
(86) PCT No.: PCT/EP04/51985

§ 371 Date: Feb. 14, 2006

(30) Foreign Application Priority Data
Nov. 21, 2003 (GB) 0327151.7

(51) Int. Cl. H04B 7/00; H04Q 7/20

(52) U.S. Cl. 455/522

(57) ABSTRACT

An outer loop power control method and apparatus for a radio communications system, for example a UMTS cellular radio communications system (60), comprising: determining that a plurality of different services are being communicated; performing a comparison with respect to the different services; and providing an inner loop power control performance target, for example a signal to interference ratio (SIR) target, in a manner dependent upon the comparison.

### FIELD OF THE INVENTION

The present invention relates to power control in radio communications systems. The present invention relates in particular, but not exclusively, to outer loop power control in cellular communications systems, for example Universal Mobile Telecommunications System (UMTS) systems.

### BACKGROUND OF THE INVENTION

Radio communications systems, for example cellular radio communications systems, are well known. In cellular radio communications systems, communication is carried out over radio links formed between base stations and subscriber units. A subscriber unit is typically a mobile telephone (also known as a “mobile” or a “cell phone”).

Recently, cellular radio communications systems compliant with the well known Universal Mobile Telecommunications System (UMTS) standard have been implemented. In UMTS terminology, a base station is known as a Node-B, and a subscriber unit is known as a User Equipment (UE). UMTS is particularly suitable for communicating both voice and data, including so called multi-media data.

In radio communications systems, for example in cellular radio communications systems, power control is employed to attempt to avoid unnecessarily high levels of radio transmission power being used. Power control may be employed to control the power level of transmission from a base station to a subscriber unit and/or from a subscriber unit to a base station. Broadly speaking, the power is adjusted to be sufficiently high to meet a performance target or criterion, but no higher than is required to achieve this performance target or criterion.

In UMTS, the performance target employed in power control is that of signal to interference ratio (SIR). Power control is implemented by determining the SIR, usually at every timeslot (which in UMTS is every 0.67 msec). The determined SIR is compared to a SIR target, and the power level is adjusted accordingly. This is referred to as inner loop power control.

Some communications systems further implement outer loop power control. In outer loop power control, a further performance aspect is monitored. The value of the performance target used in the inner loop power control is then varied according to the monitored level of the further performance aspect. This variation is carried out at a less frequent rate than the inner loop power control assessments and adjustments. In UMTS, the further performance aspect may be chosen as any one of various Quality of Service (QoS) parameters, but typically Frame Erasure Rate (FER) is used for voice communication and Block Error Rate (BLER) is used for data communication. In UMTS, the outer loop power control is implemented such that the inner loop performance target is varied (or potentially varied) every few hundred microseconds.

A further detail in relation to UMTS, and potentially other radio communications systems communicating differing types of data, e.g. multi-media, is that different types of data (i.e. different services) may require different values of the SIR target to be employed in the inner loop power control, due to differing quality of service needs. For example, a real-time video service may require a higher SIR than a real-time voice service due to more detail being required. Another example is that any such real-time service may require a higher SIR than data services that are not real-time, e.g. downloading of static web pages.

Conventionally, any conflict arising from these differing requirements has not been considered or addressed.

### SUMMARY OF THE INVENTION

The present inventors have realised that it would be desirable to modify the conventional outer loop power control process when two or more differing services are being communicated.

In a first aspect, the present invention provides an outer loop power control method performed in a radio communications system, the method comprising: determining that a plurality of different services are being communicated; performing a comparison with respect to the different services; and providing an inner loop power control performance target in a manner dependent upon the comparison.

In a further aspect, the present invention provides an outer loop power control method performed in a radio communications system, the method comprising: selecting one of a plurality of services being communicated; and providing the inner loop power control performance target of the selected service for use in an inner loop power control method for the services. Selecting the one service may comprise selecting the service which is the least delay tolerant service. Selecting the one service may be based upon a comparison of one or more quality of service characteristics or requirements of the services. Selecting the one service may comprise receiving an input from a user or operator specifying the service.

In a further aspect, the present invention provides an outer loop power control method performed in a radio communications system, the method comprising: periodically calculating for each of a plurality of different services being communicated, a separate change to the current inner power loop performance target; comparing the resulting respective current inner power loop performance target changes; identifying the largest of the resulting respective current inner power loop performance target changes; and changing the current inner power loop performance target by the amount of the identified largest resulting respective current inner power loop performance target changes to arrive at the inner loop power control performance target being provided.

In a further aspect, the present invention provides an outer loop power control method performed in a radio communications system, the method comprising: periodically calculating, for each of a plurality of different services, a separate new inner loop power control performance target value; comparing the resulting respective inner loop power control performance target values; identifying the highest inner loop power control performance target value from among the resulting respective inner loop power control performance target values; and using the identified highest inner loop power control performance target value as the inner loop power control performance target being provided. In this aspect, the method may further comprise: determining that one of the resulting respective inner loop power control performance target values differs from the resulting respective inner loop power control performance target value of one or more of the other services by more than a predetermined threshold for more than a predetermined time; and responsive thereto, adjusting rate matching parameters of one or more of the services to bring the differing respective inner loop power control performance target value closer to the resulting respective inner loop power control performance target values of the one or more other services.

In any of the above aspects, the inner loop power control performance target may be a signal to interference ratio, SIR, target.

In any of the above aspects, the radio communication system may be a cellular radio communications system, and in particular may be a UMTS system.

In a further aspect, the present invention provides a storage medium storing processor-implementable instructions for controlling a processor to carry out the method of any of the above mentioned aspects.

In a further aspect, the present invention provides an apparatus for performing an outer loop power control method in a radio communications system, comprising: means for determining that a plurality of different services are being communicated; means for performing a comparison with respect to the different services; and means for providing an inner loop power control performance target in a manner dependent upon the comparison.

In a further aspect, the present invention provides an apparatus for performing an outer loop power control method in a radio communications system, comprising means for selecting one of a plurality of services being communicated; and means for providing the inner loop power control performance target of the selected service for use in an inner loop power control method for the services. The means for selecting the one service may comprise means for selecting the service which is the least delay tolerant service. The means for selecting the one service may comprise means for basing the selection upon a comparison of one or more quality of service characteristics or requirements of the services. The means for selecting the one service may comprise means for receiving an input from a user or operator specifying the service.

In a further aspect, the present invention provides an apparatus for performing an outer loop power control method in a radio communications system, comprising: means for periodically calculating, for each of a plurality of services being communicated, a separate change to the current inner power loop performance target; means for comparing the resulting respective current inner power loop performance target changes; means for identifying the largest of the resulting respective current inner power loop performance target changes; and means for changing the current inner power loop performance target by the amount of the identified largest resulting respective current inner power loop performance target changes to arrive at the inner loop power control performance target being provided. The apparatus may further comprise: means for periodically calculating, for each of the services, a separate new inner loop power control performance target value; the means for performing a comparison with respect to the different services may comprise means for comparing the resulting respective inner loop power control performance target values; means for identifying the highest inner loop power control performance target value from among the resulting respective inner loop power control performance target values; and means for using the identified highest inner loop power control performance target value as the inner loop power control performance target being provided. The apparatus may further comprise: means for determining that one of the resulting respective inner loop power control performance target values differs from the resulting respective inner loop power control performance target value of one or more of the other services by more than a predetermined threshold for more than a predetermined time; and means for adjusting, responsive thereto, rate matching parameters of one or more of the services to bring the differing respective inner loop power control performance target value closer to the resulting respective inner loop power control performance target values of the one or more other services.

In each of the above mentioned apparatus, the inner loop power control performance target may be a signal to interference ratio, SIR, target.

Each of the above mentioned apparatus may be an element of a cellular radio communications system, in particular a UMTS system.

The present invention tends to alleviate or resolve conflict arising from differing requirements with respect to outer loop power control of different services being communicated. The present invention tends to provide an improved balance between quality of service requirement and overall power consumption when different services are being communicated.

### BRIEF DESCRIPTION OF THE DRAWINGS

Embodiments of the present invention will now be described, by way of example only, with reference to the accompanying drawings, in which:

FIG. 1 is a schematic illustration of a cellular communications system compliant with, and containing network elements of, UMTS;

FIG. 2 is a block diagram of a communications unit;

FIG. 3 is a process flowchart showing a summary of the process steps carried out in a first embodiment of the invention;

FIG. 4 is a process flowchart showing a summary of the process steps carried out in a second embodiment of the invention;

FIG. 5 is a schematic illustration showing simplified plots of SIR targets provided in the case of two services as a function of time;

FIG. 6 is a process flowchart showing a summary of the process steps carried out in a third embodiment of the invention;

FIG. 7 is a schematic illustration showing further simplified plots of SIR targets provided in the case of two services as a function of time; and

FIG. 8 is a process flowchart showing a summary of the process steps carried out in a fourth embodiment of the invention.

### DESCRIPTION OF PREFERRED EMBODIMENTS

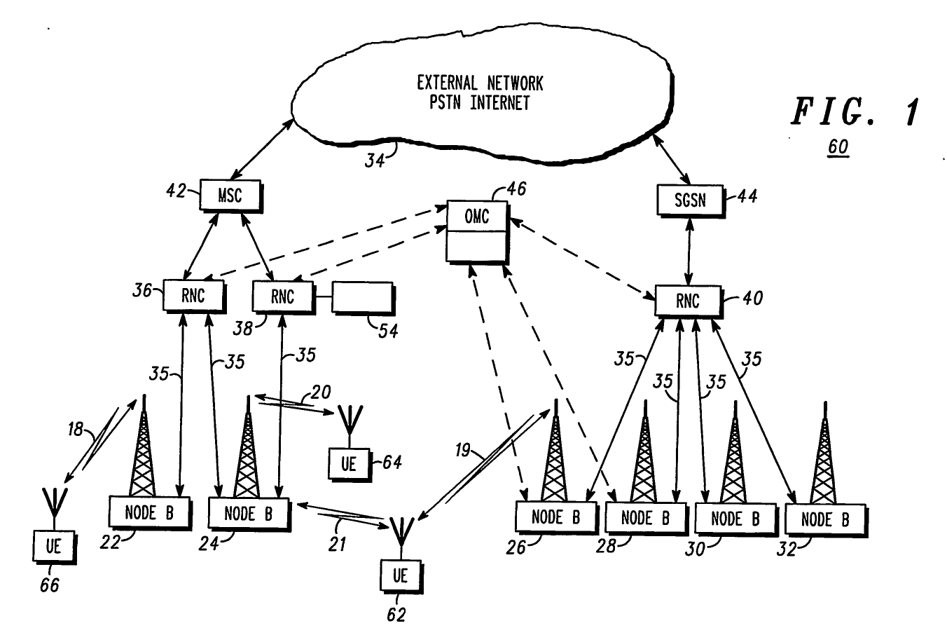

FIG. 1 is a schematic illustration of a cellular communications system 60 compliant with, and containing network elements of, UMTS.

A plurality of mobile stations, referred to under UMTS terminology as user equipments (UE's) 62, 64, 66 communicate over radio links 18, 19, 20, 21 with a plurality of base stations, referred to under UMTS terminology as Node-B's, 22, 24, 26, 28, 30, 32. The system comprises many other UE's and base stations, which for clarity are not shown. In this example each UE 62, 64, 66 is a mobile telephone equipped with multi-media and internet browsing capability.

The Node-B's 22-32 are connected to external networks, for example, the public-switched telephone network (PSTN) or the Internet, 34 through base station controllers, referred to under UMTS terminology as Radio Network Controller stations (RNC), including the RNC's 36, 38, 40 and mobile switching centres (MSC's), such as MSC 42 (the others are, for clarity, not shown) and Serving GPRS Support Nodes (SGSN) such as SGSN 44 (the others are, for clarity, not shown).

Each Node-B 22-32 contains one or more transceiver units and communicates with the rest of the cell-based system infrastructure via the Iub interface 35 as defined in the UMTS specification.

Each RNC 36-40 may control one or more Node-B's 22-32. Each MSC 42 provides a gateway to the external network 34, whilst the SGSN 44 links to external packet networks.

The Operations and Management Centre (OMC) 46 is operably connected to RNC's 3640 and Node-B's 22-32 (shown only with respect to Node-B 26 and Node-B 28 for clarity), and administers and manages the parts of the cellular telephone communication system 60, as will be understood by those skilled in the art.

In this embodiment, the Node-B's 22-32 and the UE's 62-66 have been adapted, to offer, and provide for, an adapted form of outer loop power control, as will be described in more detail below. More particularly, in this embodiment both the Node-B's 22-32 and the UE's 62-66 have been adapted to implement the present invention, such that in this embodiment the invention may be applied to both downlink (from Node-B to UE) and uplink (from UE to Node-B) transmissions. However, in other embodiments the invention may be applied by adapting just one of the types of communications units (Node-B's or UE's).

More generally, the adaptation may be implemented in the respective communications units in any suitable manner. For example, new apparatus may be added to a conventional communications unit, or alternatively existing parts of a conventional communications unit may be adapted, for example by reprogramming of a one or more processors therein. As such the required adaptation may be implemented in the form of processor-implementable instructions stored on a storage medium, such as a floppy disk, hard disk, PROM, RAM or any combination of these or other storage media.

It is also within the contemplation of the invention that such adaptation of transmission characteristics may alternatively be controlled, implemented in full or implemented in part by adapting any other suitable part of the communications system 60. For example, the RNC's 36-40 (pr equivalent parts in other types of systems) may be adapted to provide some or all of the implementation provided in this embodiment by the Node-B's 22-30. Further, in the case of other network infrastructures, implementation may be at any appropriate node such as any other appropriate type of base station, base station controller etc. Alternatively the various steps involved in determining and carrying out such adaptation (as will be described in more detail below) can be carried out by various components distributed at different locations or entities within any suitable network or system.

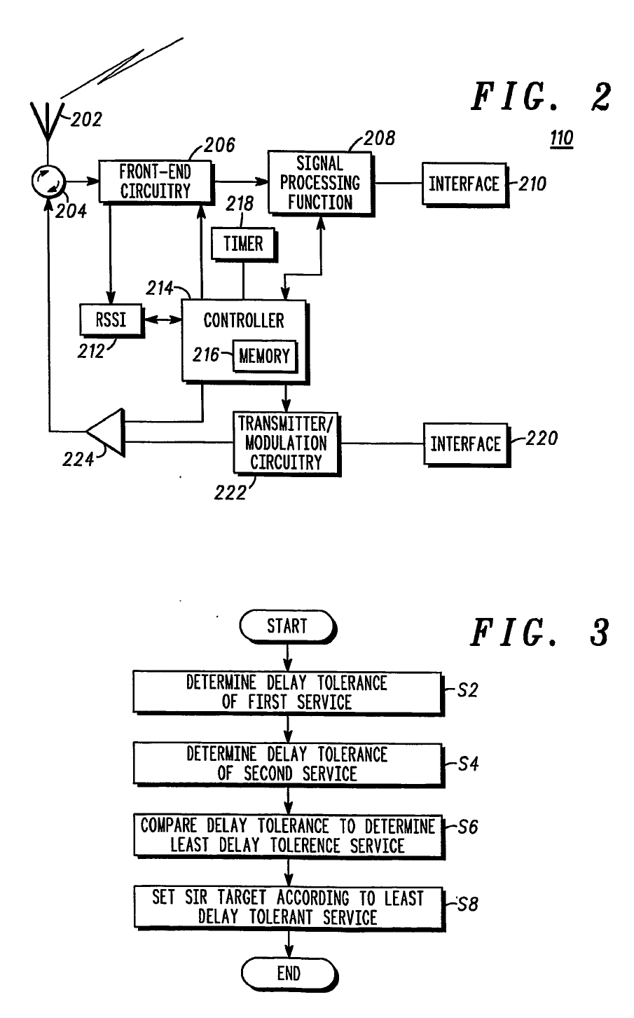

As mentioned above, in this embodiment both the Node-B's 22-30 and UE's 62-66 are adapted such that the invention may be applied in both uplink and downlink direction. As such the following description will be made in terms of downlink transmission from Node-B 24 to UE 62 over radio link 21, but it will be appreciated the description applies also to uplink transmission from UE 62 to Node-B 24, and so on. Also, in this embodiment Node-B 24 and UE 62 are of the same basic form with respect to aspects relevant to understanding this embodiment, and thus each constitute a basic communications unit 110 as illustrated in block diagram form in FIG. 2, and which will now be referred to in the further description of this embodiment.

Each communications unit 110 contains an antenna 202 coupled to a duplex filter or circulator 204 that provides isolation between receive and transmit chains within the communications unit 110.

The receiver chain, as known in the art, includes scanning receiver front-end circuitry 206 (effectively providing reception, filtering and intermediate or base-band frequency conversion). The scanning front-end circuit is serially coupled to a signal processing function 208.

An output from the signal processing function is provided to output 210. In the case of UE 62, output 210 includes a loudspeaker for audio output, a display and a data services output. In the case of Node-B 24, output 210 comprises interface means for communicating with RNC 38.

The receiver chain also includes received signal strength indicator (RSSI) circuitry 212, which in turn is coupled to a controller 214 that operates to maintain overall control of the different functions and modules of the communications unit 110. The controller 214 is also coupled to the scanning receiver front-end circuitry 206 and the signal processing function 208 (generally realised by a digital signal processor, i.e. DSP).

The controller 214 includes a memory 216 that stores operating regimes, including those of interest with respect to this invention such as coding and interleaving (when transmitting) and decoding (when receiving). The above mentioned storage medium may form part or all of memory 216.

A timer 218 is typically coupled to the controller 214 to control the timing of operations (transmission or reception of time-dependent signals) within the communications unit 110.

As regards the transmit chain, this includes an input 220. In the case of UE 62, input 220 includes a microphone for a user's voice input, and a keyboard. In the case of Node-B 24, input 220 comprises interface means for receiving communication from RNC 38. The input devices are each coupled in series through transmitter/modulation circuitry 222 and a power amplifier 224 to the antenna 202. The transmitter/modulation circuitry 222 and the power amplifier 224 are operationally responsive to the controller.

The various components within each communications unit 110 are realised in this embodiment in integrated component form. Of course, in other embodiments, they may be realized in discrete form, or a mixture of integrated components and discrete components, or indeed any other suitable form. Further, in this embodiment the controller 214 including some or all of memory 216, is implemented as a programmable processor, but in other embodiments can comprise dedicated circuitry or any other suitable form (for example a part of memory 216 may be in RAM form integrated with a processor, whereas a further part may be provided by a floppy disk or CD-RAM.

Certain details of the implementation of the inner loop and outer loop power control processes will now be described. First, the situation when just one service is being communicated will be described.

For the inner loop power control, the performance target employed is that of signal to interference ratio (SIR). Power control is implemented by determining the SIR, usually at every timeslot (which in UMTS is every 0.67 msec). The determined SIR is compared to a SIR target, and the power level is adjusted accordingly. Thus, in terms of downlink transmission from Node-B 24 to UE 62 over radio link 21, and considering UE62 as constituted by communications unit 110, controller 214 assesses the SIR for transmissions it receives from Node-B 24 against the relevant SIR target, and then transmits a resulting power control instruction (known as transmit power control, TPC) to the Node-B 24 such that Node-B 24 can then adjust its transmitted power accordingly.

Furthermore, by virtue of the outer loop power control, the value of the SIR target used by the UE 62 in the process described in the preceding paragraph is itself varied by controller 214 of UE 62. This variation is carried out at a less frequent rate than the inner loop power control assessments and adjustments, in this example every few hundred microseconds. The controller 214 of UE 62 monitors a further performance aspect, and then determines changes in the SIR target dependent upon the monitored level of the further performance aspect, using an outer loop power control algorithm, such as the sawtooth algorithm.

In UMTS, the further performance aspect may be chosen as any one of various Quality of Service (QoS) parameters, but typically Frame Erasure Rate (FER) is used for voice communication and Block Error Rate (BLER) is used for data communication.

It is noted that corresponding features to those described above with respect to communications unit 110 are also found in conventional communications units (i.e. base stations and UE's). Likewise, the inner and outer loop power control processes described above are also implemented in conventional communications units (i.e. base stations and UE's). However, communications unit 110 (i.e. Node-B 24 and UE 62) differ over conventional communications units by virtue that the controller 214, including memory 216, and where appropriate, the signal processing function 208 and the transmitter/modulation circuitry 222 is adapted to provide an adapted form of the outer loop power control process, when plural services are being communicated (i.e. each of the plural services is carried on a respective transport channel of the same physical channel), as will be described in more detail below.

In this first embodiment, when plural services are being communicated, only one outer loop power control algorithm, i.e. for one of the services, is performed, and this provides the SIR target for use in the inner loop power control algorithm. The service whose SIR target is used as the sole SIR target may be selected in various ways.

For example, the least delay tolerant of the services may be selected.

Another possibility is that the selection of the service may be based upon a comparison of one or more quality of service characteristics or requirements of the services.

Another possibility is that the service may be selected by a user of the UE 62 or an operator of part or all of the system 60. In this case, the UE 62 or system 60 receives an input from a user or operator specifying the service to be selected. The user or operator may be prompted to choose, or otherwise chooses, to select the service he considers to be the most important of the plural services according to his needs.

In this embodiment, the service selected is the least delay tolerant one, and hence the SIR target normally used for the selected least delay tolerant service is used as the SIR target for the outer loop power control.

More generally, the selection of the service whose SIR target is used as the sole SIR target may be made according to various possibilities, which may in general be specified according to the requirements of the particular system or circumstances under consideration.

FIG. 3 is a process flowchart showing a summary of the process steps carried out in this first embodiment by the UE 62 (for the present account of power control as applied to the downlink transmission), when there are two services being communicated, e.g. a (first) speech service and a (second) data service. At step s2, the UE 62 determines the delay tolerance of the first service. At step s4, the UE 62 determines the delay tolerance of the second service. At step s6, the UE 62 compares the determined delay tolerances and determines which is the least delay tolerant of the services. At step s8, the UE 62 sets and uses its SIR target as that normally used by the determined least delay tolerant service. For power control as applied to the uplink transmission, corresponding process steps are performed by the Node-B 24 (or RNC 38).

A second embodiment will now be described. In this second embodiment, the same apparatus and processes as described for the first embodiment above are employed, except where mentioned in the following.

In UMTS, a Time Transmission Interval (TTI) is defined, which is a period of coding and interleaving. The length of this will depend on the service being communicated or provided, and will usually have a duration of one of 10 msec, 20 msec, 40 msec or 80 msec.

In this second embodiment, a single SIR target is initially set. At the end of each TTI, the block errors and quality estimates for each of the plural transport channels (each one carrying a respective one of the plural services) are used to determine a respective potential change in the SIR target. Thus, for example, in the case of two services, at the end of each TTI, two different potential SIR target change values are determined, one derived from each service. Any suitable outer loop power control algorithm may be used for this, e.g. a sawtooth algorithm. Then the plural (here, two) calculated potential SIR target changes are compared, and the greater of the two is used as the actual SIR target change, i.e. the SIR target used in the inner power loop control algorithm over the course of the next TTI is changed by an amount equal to the greater of the two derived potential SIR target change values. This provides a process whereby the requirements of both services tend to be met or exceeded.

In other versions of this second embodiment, the respective potential changes in the SIR target may be determined at time intervals other than at the end of each TTI. Such time intervals may be constant, or varied according to any suitable algorithm, and may be based upon TTI's or any other suitable timing consideration.

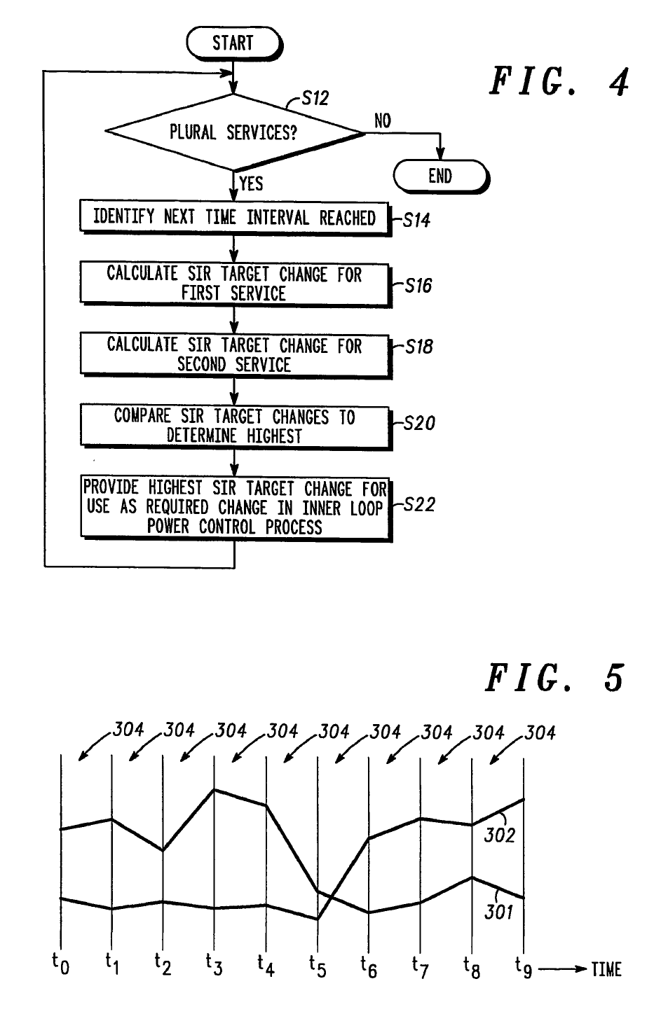

FIG. 4 is a process flowchart showing a summary of the process steps carried out in this second embodiment by the UE 62 (for the present account of power control as applied to the downlink transmission), when there are two services being communicated, e.g. a (first) speech service and a (second) data service. At step s12, the UE 62 determines whether there are plural services being communicated. When the outcome is that there are not plural services, then this particular process is ended (although it will typically be repeated whenever the service status is detected as changed by virtue of some other ongoing process). However, when the outcome is that there are indeed plural services, then the process moves to step s14. At step s14, the UE 62 identifies that the next time interval is reached, i.e. in this embodiment that the TTI has ended. In this embodiment there are two services being communicated, hence at step s16, the UE 62 calculates a SIR target change for the first service and at step s18, the UE 62 calculates a SIR target change for the second service. At step s20, the UE 62 compares the two respective services' SIR target changes and determines which is the highest. At step s22, the UE 62 provides the highest (here higher of two) SIR target change for use as the required change or increment in the inner loop power control process, i.e. the highest of the determined SIR target changes is provided for use in the inner loop power control process where the inner loop power control SIR target is consequently changed by that amount. The process then returns to step s12, and so on, until it is determined on one of the repetitions of step s12 that there are no longer plural services being communicated. (The actual use of the highest SIR target change in the inner loop power control process is not shown as such in FIG. 4, as the timing of this is not necessarily consistent with the return to step s12 from step s22 in the process flowchart of FIG. 4.)

For power control as applied to the uplink transmission, corresponding process steps are performed by the Node-B 24 (or RNC 38).

Thus, in overview, in this second embodiment, a separate correction to the SIR target is periodically, i.e. at time intervals, calculated for each respective service. For each such time interval, the resulting respective required SIR target changes are compared, and the highest change is used as the overall derived correction to the SIR target from that time interval.

A third embodiment will now be described. In this third embodiment, the same apparatus and processes as described for the first and second embodiments above are employed, except where mentioned in the following.

In this third embodiment, a separate respective outer loop power control algorithm is performed for each of the plural services being communicated. Thus plural outer loop power control algorithms are run in parallel. Consequently, after each calculation time interval of the algorithms, a respective current SIR target will have been calculated for each service. FIG. 5 is a schematic illustration showing, by way of example, simplified plots of the SIR targets provided in the case of two services, namely a plot 301 of the SIR target calculated for the first service (data, say) and a plot 302 of the SIR target calculated for the second service (voice, say) as a function of time. As shown in FIG. 5, each of the plots is formed of values of the respective SIR targets determined at consecutive time points t₀, t₁, t₂ . . . t₉, each of these occurring at the end of a time interval 304. In this embodiment, each time interval 304 is a TTI, and each time point t₀, t₁, t₂ . . . t₉, is at the end of a respective TTI. For clarity, the plots 301, 302 in FIG. 5 are only shown over the course of nine time intervals 304, however it will be appreciated that in normal operation there will be a very large number of time intervals over the course of, say, a typical call.

In this third embodiment, at each time point t₀, t₁, t₂ . . . t₉, the respective SIR targets of the different services are compared, and the highest one is used as the SIR target, i.e. the value for the SIR target used in the inner power loop control algorithm over the course of the next ITI is the highest SIR target from amongst the respective SIR targets determined for each service. In the example shown in FIG. 5, as can be seen by comparing plot 301 of the SIR target of the first service with plot 302 of the SIR target of the second service, the SIR target of the first service is higher than the SIR target of the second service for time points t₀ to t₅ inclusive; whereas the SIR target of the second service is higher than the SIR target of the first service for time points t₆ to t₉ inclusive. Thus, in this example, the SIR target of the first service is used in the inner loop power control process as the overall SIR target for time points t₀ to t₅, whereas the SIR target of the second service is used in the inner loop power control process as the overall SIR target for time points t₆ to t₉.

As in the case of the earlier described second embodiment, this third embodiment provides a process whereby the requirements of both services tend to be met or exceeded, but in comparison to the second embodiment provides a further potential advantage of consuming less power than the second embodiment, since there will potentially be occasions when the SIR target is decremented in this third embodiment but would have been incremented in the second embodiment.

In other versions of this third embodiment, the respective SIR targets may be determined at time intervals other than at the end of each TFI. Such time intervals may be constant, or varied according to any suitable algorithm, and may be based upon TTI's or any other suitable timing consideration.

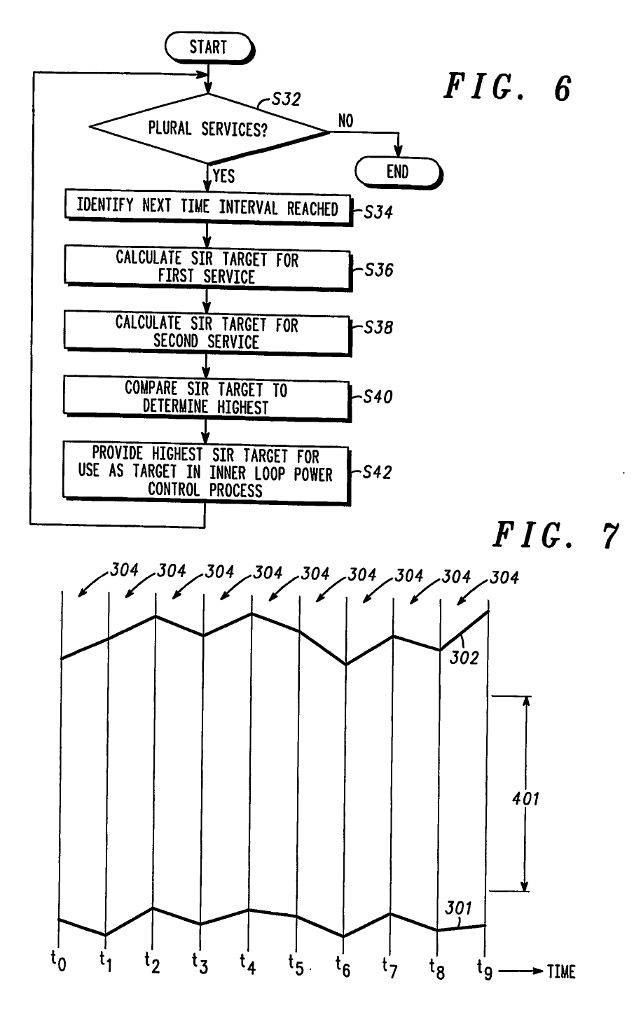

FIG. 6 is a process flowchart showing a summary of the process steps carried out in this third embodiment by the UE 62 (for the present account of power control as applied to the downlink transmission), when there are two services being communicated, e.g. a (first) speech service and a (second) data service. At step s32, the UE 62 determines whether there are plural services being communicated. When the outcome is that there are not plural services, then this particular process is ended (although it will typically be repeated whenever the service status is detected as changed by virtue of some other ongoing process). However, when the outcome is that there are indeed plural services, then the process moves to step s34. At step s34, the UE 62 identifies that the next time interval is reached, i.e. in this embodiment that the ITI has ended. In this embodiment there are two services being communicated, hence at step s36, the UE 62 calculates a SIR target value for the first service and at step s38, the UE 62 calculates a SIR target value for the second service. At step s40, the UE 62 compares the two respective services' SIR targets and determines which is the highest. At step s42, the UE 62 provides the highest (here higher of two) SIR target values for use as the updated SIR target value in the inner loop power control process, i.e. the highest of the determined SIR targets is provided for use as the SIR target in the inner loop power control process. The process then returns to step s12, and so on, until it is determined on one of the repetitions of step s12 that there are no longer plural services being communicated. (In practise, the UE 62 will typically also actually use the provided highest SIR target value as the SIR target in the inner loop power control process, but this is not shown as such in FIG. 6 as the timing of this is not necessarily consistent with the return to step s32 from step s42 in the process flowchart of FIG. 6.)

For power control as applied to the uplink transmission, corresponding process steps are performed by the Node-B 24 (or RNC 38).

Thus, in overview, in this third embodiment, a separate new SIR target value is periodically, i.e. at time intervals, calculated for each respective service. For each such time interval, the resulting respective SIR targets are compared and the highest SIR target value is used as the overall new SIR target value from that time interval.

A fourth embodiment will now be described. In this fourth embodiment, the same apparatus and processes as described for the first, second and third embodiments above are employed, except where mentioned in the following.

This fourth embodiment is based on the above described third embodiment, but comprises a further adjustment stage, in which if it is determined that the calculated SIR target of any of the services is, over a predetermined amount of time, or predetermined number of time intervals, particularly high or low compared to the calculated SIR targets of the other services, for example the difference is greater than a predetermined threshold, then the rate matching parameters of one or more of the services are adjusted to bring the particularly high or low SIR target and the SIR targets of the other services closer together.

A situation where this may be applied is for the case of the SIR targets provided according to the method of the third embodiment above if their values with time are found to be of, say, a form as shown schematically in FIG. 7. FIG. 7 is a schematic illustration showing, by way of another example, further simplified plots of the SIR targets provided in the case of two services. FIG. 7 uses the same reference numerals to identify the same features as were used in FIG. 5.

In the example of FIG. 7, the plot 302 of the SIR target calculated for the second service is higher than plot 301 of the SIR target calculated for the first service by more than a predetermined threshold 401 over the course of a predetermined number of TTI time intervals 304, which in this simplified example is nine time intervals. (In practical systems, rather than this simplified example, the number of time intervals required to be satisfied will typically be much higher than this, and will be specified or selected, along with the difference threshold 401, by the skilled practitioner according to the requirements of the particular system or circumstances under consideration.) This implies that the quality of service of the second service may be better than it needs to be, with unnecessarily high consumption of power. The power/performance balance is potentially improved by the following process carried out in this fourth embodiment.

In response to the difference between the respective SIR targets of the two services being more than a predetermined threshold for more than a predetermined time, the rate matching parameters of both services are altered, to bring the respective SIR targets closer together. In particular, repetition is added to the first service, and puncturing is added to the second service. This may be implemented in any suitable fashion, although in this embodiment this is conveniently implemented mid-call using existing messages known as Radio Resource Control (RRC) message Transport Channel Reconfigure. (In other versions of this embodiment, the adjustment comprises only either repetition being added to the first service or puncturing being added to the second service. In the case of more than two services, any combination of adding repetition to one or more of the services with relatively lower SIR target, and/or adding puncturing to one or more of the services with relatively higher SIR target may be employed.)

More generally, in other versions of this fourth embodiment, the adjustment may be triggered by comparison of an average difference between the SIR targets of plural services over a given time to the predetermined difference threshold.

Furthermore, the above described monitoring of the differential with respect to the predetermined threshold 401 may be carried out at all times, or triggered by any predetermined event or parameter values as required. One particular possibility is to trigger this process when the process described for the third embodiment above continues for a given amount of time or number of time intervals without the respective plots of the SIR targets of the two services “crossing over”, i.e. changing with respect to which is the higher value (or in the case of more than two services, when the plot of the SIR target of one service does not cross over any of the plots of the other services during a given amount of time or number of time intervals).

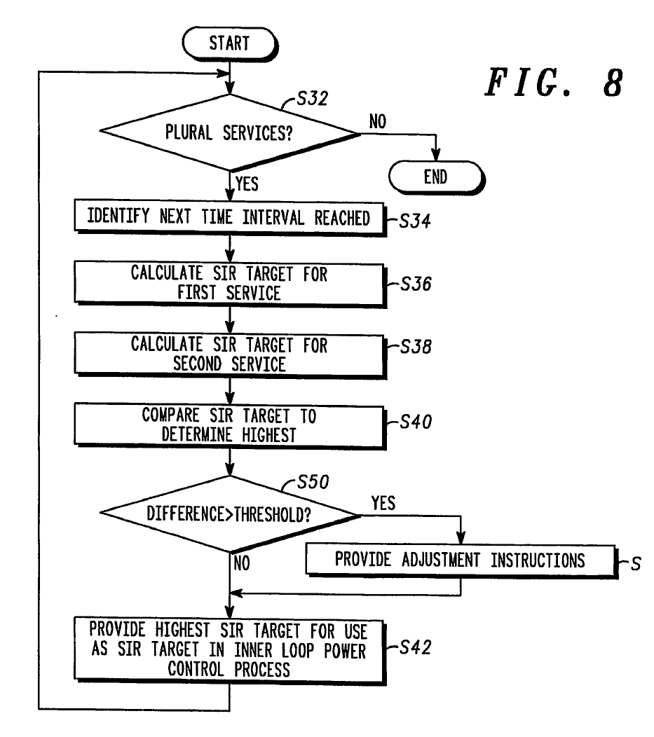

FIG. 8 is a process flowchart showing a summary of the process steps carried out in this fourth embodiment by the UE 62 (for the present account of power control as applied to the downlink transmission), when there are two services being communicated, e.g. a (first) speech service and a (second) data service. Steps s32, s34, s36, s38, s40 and s42 are as described above for the third embodiment.

In addition, after step s40, at step s50, the difference between the SIR targets of the two services is compared to a criterion or criteria. In this example, the criteria are that the difference in the SIR targets at this time interval 304 is greater than the predetermined threshold 401, and that this is the ninth consecutive time interval 304 for which this is the case. If these criteria are not met, then the process moves to step s42. However, if these criteria are met, then the process moves to step s52. At step s52, the UE 62 provides (internal) adjustment instructions for adjusting the rate matching parameters on the first service and/or the second service. In this example, the adjustment instructions are for adding repetition to the first service and adding puncturing to the second service. The process then moves on to step s42. (In practise, the UE 62 will typically also actually implement the provided adjustment instructions, but this is not shown as such in FIG. 8, as the timing of this is not necessarily consistent with the return to step s32 from step s42 in the process flowchart of FIG. 6.)

For power control as applied to the uplink transmission, corresponding process steps are performed by the Node-B 24 (or RNC 38).

In the flowcharts of FIGS. 4, 6 and 8, all process steps are shown (and described in the corresponding part of the description) as being implemented one after the other, but it will be appreciated that many of the steps, for example step s2 and step s4 in FIG. 3, step s16 and step s18 in FIG. 4, and step s36 and step s38 in FIG. 6 and FIG. 8, may be performed at the same time in parallel or in some other overlapping manner.

Although in certain of the above embodiments the number of different services is two, it will be appreciated that the invention is applicable to pluralities of services comprising more than two services. Also, in the case of two or more services, one of the services of the plurality of services may in fact be a signalling channel.

In the above embodiments the inner loop power control performance target is a SIR target, but in other embodiments other performance targets may be employed.

The above embodiments are implemented in a cellular radio communications system, more particularly a UMTS system, in which inner loop power control and outer loop power control are defined in the UMTS standards and are well known to the skilled person. However, other embodiments may be implemented in other types of cellular radio communications systems, and more generally in other types of radio communications systems, which have inner loop power control and outer loop power control. The terms “inner loop power control” and “outer loop power control” are to be understood to extend, as appropriate in the case of radio communications systems other than UMTS, to any power control arrangements, processes or algorithms in which a first parameter or plurality of parameters or function is assessed against a target on a first timescale to determine possible power changes (i.e. inner loop power control) and where the target itself is adjusted in view of a second parameter or plurality of parameters or function on a second timescale longer than the first timescale (i.e. outer loop power control), even if such power control aspects are not called “inner loop” and “outer loop” as such in the terminology usually used for such systems.

1. An outer loop power control method performed in a radio communications system, the method comprising:
determining that a plurality of different services are being communicated;
performing a delay tolerance comparison with respect to the different services;
selecting the service having the least delay tolerant service; and
providing an inner loop power control performance target of the selected service in a manner dependent upon the delay tolerance comparison.

2-3. (canceled)

4. A method according to claim 1, wherein selecting one of the services is also performed based upon a comparison of one or more quality of service characteristics or requirements of the services.

5. A method according to claim 1, wherein selecting one of the services comprises receiving an input from a user or operator specifying the service.

6. A method according to claim 1, further comprising:
periodically calculating, for each of the services, a separate change to the current inner power loop performance target;
wherein performing a comparison with respect to the different services comprises comparing the resulting respective current inner power loop performance target changes;
identifying the largest of the resulting respective current inner power loop performance target changes; and
changing the current inner power loop performance target by the amount of the identified largest resulting respective current inner power loop performance target changes to arrive at the inner loop power control performance target being provided.

7. A method according to claim 1, further comprising:
periodically calculating, for each of the services, a separate new inner loop power control performance target value;
wherein performing a comparison with respect to the different services comprises comparing the resulting respective inner loop power control performance target values;
identifying the highest inner loop power control performance target value from among the resulting respective inner loop power control performance target values; and
using the identified highest inner loop power control performance target value as the inner loop power control performance target being provided.

8. A method according to claim 7, further comprising:
determining that one of the resulting respective inner loop power control performance target values differs from the resulting respective inner loop power control performance target value of one or more of the other services by more than a predetermined threshold for more than a predetermined time;
responsive thereto, adjusting rate matching parameters of one or more of the services to bring the differing respective inner loop power control performance target value closer to the resulting respective inner loop power control performance target values of the one or more other services.

9. A method according to claim 1, wherein the inner loop power control performance target also includes a signal to interference ratio, SIR, target.

10. A method according to claim 1, wherein the radio communication system is a cellular radio communications system.

11. A method according to claim 10, wherein the cellular radio communications system is a UMTS system.

12. (canceled)

13. An apparatus for performing an outer loop power control method in a radio communications system, comprising:
means for determining that a plurality of different services are being communicated;
means for performing a delay tolerance comparison with respect to the different services;
means for selecting the service having the least delay tolerant service; and
means for providing an inner loop power control performance target in a manner dependent upon the delay tolerance comparison.

14-15. (canceled)

16. The Apparatus according to claim 13, wherein the means for selecting one of the services also comprises means for basing the selection upon a comparison of one or more quality of service characteristics or requirements of the services.

17. The Apparatus according to claim 13, wherein the means for selecting one of the services comprises means for receiving an input from a user or operator specifying the service.

18. The Apparatus according to claim 13, further comprising:
means for periodically calculating, for each of the services, a separate change to the current inner power loop performance target;
wherein the means for performing a comparison with respect to the different services comprises means for comparing the resulting respective current inner power loop performance target changes;
means for identifying the largest of the resulting respective current inner power loop performance target changes; and
means for changing the current inner power loop performance target by the amount of the identified largest resulting respective current inner power loop performance target changes to arrive at the inner loop power control performance target being provided.

19. The Apparatus according to claim 13, further comprising:
means for periodically calculating, for each of the services, a separate new inner loop power control performance target value;
wherein the means for performing a comparison with respect to the different services comprises means for comparing the resulting respective inner loop power control performance target values;
means for identifying the highest inner loop power control performance target value from among the resulting respective inner loop power control performance target values; and
means for using the identified highest inner loop power control performance target value as the inner loop power control performance target being provided.

20. The Apparatus according to claim 19, further comprising:
means for determining that one of the resulting respective inner loop power control performance target values differs from the resulting respective inner loop power control performance target value of one or more of the other services by more than a predetermined threshold for more than a predetermined time;
means for adjusting, responsive thereto, rate matching parameters of one or more of the services to bring the differing respective inner loop power control performance target value closer to the resulting respective inner loop power control performance target values of the one or more other services.

21. The Apparatus according to claim 13, wherein the inner loop power control performance target also includes a signal to interference ratio, SIR, target.

22-25. (canceled)
